(19) United States
(12) Patent Application Publication
(10) Pub. No.: US 2026/0246549 A1
(43) Pub. Date: Aug. 20, 2026

(54) SYSTEMS AND METHODS FOR BEAM PREDICTION USING NEURAL NETWORK AT NETWORK NODE SIDE AND USER EQUIPMENT SIDE

(71) Applicant: Nokia Technologies Oy, Espoo (FI)

(72) Inventors: Tachporn SANGUANPUAK, Oulu (FI); Timo KOSKELA, Oulu (FI)

(21) Appl. No.: 19/161,591

(22) PCT Filed: Jan. 12, 2024
(86) PCT No.: PCT/EP2024/050675

§ 371 Date: Sep. 2, 2025

(30) Foreign Application Priority Data
Mar. 8, 2023 (FI) 20235266

(51) Int. Cl. H04B 17/318; H04B 7/06

(52) U.S. Cl. CPC H04B 17/328; H04B 7/06952

(57) ABSTRACT

Apparatus and methods for beam prediction using neural networks at a network node side and a user equipment (UE) side are disclosed. Advantages of the apparatus/methods can include a reduction in the number of measurements and frequency of measurements required for beam selection. ML models are configured using a fully connected feed forward neural network, a convolutional neural network, deep reinforcement learning, or a deep reinforcement learning based long short-term memory (LSTM) recurrent neural network (RNN). In a first aspect, the network configures a UE to perform downlink beam prediction, configures UE to report the prediction results, and utilizing the prediction results as an input for the network ML model. In a second aspect, a network side ML model training method is provided. The training method includes evaluation for the network side prediction outcome based on at least one metric, and using the metric to determine whether to update/reward the current model based on the UE input.

### FIELD

Various example embodiments relate generally to wireless networking and, more particularly, to systems and methods for beam prediction using neural networks at a network side and/or at user equipment (UE) side in wireless networking.

### BACKGROUND

Wireless networking provides significant advantages for user mobility. A user's ability to remain connected while on the move provides advantages not only for the user, but also provides greater efficiency and productivity for society as a whole. As user expectations for connection reliability, data speed, and device battery life, become more demanding, technology for wireless networking must also keep pace with such expectations. Accordingly, there is continuing interest in improving wireless networking technology.

### SUMMARY

In accordance with aspects of the present disclosure, a method includes accessing, by a user equipment apparatus (UE), a trained machine learning (ML) model configured to perform downlink (DL) beam prediction; obtaining, by the UE, DL beam identifiers (IDs) and DL beam reference signal received power (RSRP) for a plurality of DL beams; and predicting, by the UE, at least one DL beam, of the plurality of DL beams, to use for wireless communications. The predicting includes inputting at least one of the beam IDs or the DL beam RSRP to the trained ML model to obtain the DL beam prediction.

In an aspect of the present disclosure, the ML model may perform DL beam prediction in a spatial domain. The method may further include receiving, by the UE a measurement of a DL beam ID, the DL beam RSRP, and/or a DL beam signal to interference noise ratio (SINR); providing as an input to the trained ML model the at least one of the DL beam ID, the DL beam RSRP, and/or the DL beam SINR; and predicting, by the trained ML model, an SINR value for the DL beam ID for a time instance (t).

In an aspect of the present disclosure, the ML model may perform DL beam prediction in at least one of a time domain or a spatial domain. The ML model may train and take actions based on a current observation space/current state. The ML model performs prediction of at least one of network-side DL beam ID(s), RSRP of beam ID(s), or SINR of beam ID(s) based on deep reinforcement learning.

In an aspect of the present disclosure, for spatial domain predictions the ML model may be a fully connected feed forward neural network or a convolutional neural network for predicting the at least one DL beam to use for the wireless communications.

In an aspect of the present disclosure, for time domain predictions the ML model may be a recurrent neural network for predicting the at least one DL beam to use for wireless communications, the recurrent neural network including long short-term memory (LSTM).

In an aspect of the present disclosure, for time domain predictions, inputs for the ML model may be sequenced in time, and outputs for the ML model may be sequenced in time.

In an aspect of the present disclosure, for the DL beam prediction for one or more DL beam ID(s) may be further based on at least one of an antenna panel index or a receive (RX) beam index received at the UE.

In an aspect of the present disclosure, the method may further include transmitting, by the UE, one or more prediction outputs values of the UE ML model as an input to a network side ML model, wherein the transmitted one or more prediction output values are configured to cause the network side ML model to generate a prediction output based on the input received from the UE.

In accordance with aspects of the present disclosure, a user equipment apparatus includes at least one processor and at least one memory. The at least one memory storing instructions which, when executed by the at least one processor, cause the user equipment apparatus at least to: access a trained machine learning (ML) model configured to perform downlink (DL) beam prediction; obtain, DL beam identifiers (IDs) and DL beam reference signal received power (RSRP) for a plurality of DL beams; and predict, at least one DL beam, of the plurality of DL beams, to use for wireless communications, the predicting including inputting at least one of the beam IDs or the DL beam RSRP to the trained ML model to obtain the DL beam prediction.

In accordance with aspects of the present disclosure, a method includes accessing, by a network apparatus, a trained machine learning (ML) model configured to perform network-side DL beam prediction; receiving, by the network apparatus, a downlink (DL) beam prediction provided by a user equipment apparatus (UE), a UE-side DL beam prediction identifying at least one beam, among a plurality of beams generated by the network apparatus, to use for wireless communications; and performing, by the network apparatus, the network-side DL beam prediction by inputting the UE-side DL beam prediction to the trained ML model to identify at least one of the plurality of beams to use for the wireless communications.

In an aspect of the present disclosure, the trained ML model may include at least one of a long short-term memory (LSTM) recurrent neural network (RNN) or a deep learning LSTM RNN.

In an aspect of the present disclosure, the ML model may perform network-side DL beam prediction in at least one of a time domain or a spatial domain.

In an aspect of the present disclosure, inputs for the ML model may include at least one of a DL beam index, a DL beam ID, reference signal received power (RSRP), an antenna panel index, or a beam index received at the UE.

In an aspect of the present disclosure, the ML model may predict at least one of the DL beam ID(s), RSRP of beam ID(s), or SINR of beam ID(s) in both time domain and spatial domain based on the inputs for the ML model.

In an aspect of the present disclosure, the inputs for the ML model may be sequenced in time, and outputs for the ML model are sequenced in time.

In an aspect of the present disclosure, the method may further include estimating, by the network apparatus, a reliability of the of the UE prediction and determining whether to update the ML model based on a reward/penalty calculation.

In an aspect of the present disclosure, the method may further include for each prediction, obtaining at least one DL beam ID prediction provided by the ML model to determine whether a new serving beam is configured for at least one of PUSCH, PUCCH, PDSCH, or PDCCH.

In an aspect of the present disclosure, determining whether to update the ML model or not, may be based on using at least one quality-based metric, wherein a quality-based criteria includes one or more of the following: i) a beam failure or ii) a predicted CQI value based on a predicted RSRP iii) a predicted SINR value to map to CQI value.

In accordance with aspects of the present disclosure, a network apparatus, includes at least one processor and at least one memory. The at least one memory stores instructions which, when executed by the at least one processor, cause the network apparatus at least to: access a trained ML model configured to perform network-side DL beam prediction, wherein the trained ML model includes at least one of a trained long short-term memory (LSTM) recurrent neural network (RNN) or a trained deep reinforcement learning model; receive a downlink (DL) beam prediction provided by a user equipment apparatus (UE), a UE-side DL beam prediction identifying at least one beam, among a plurality of beams generated by the network apparatus, to use for wireless communications; receive downlink (DL) beam measurements performed by the UE; and perform the network-side DL beam prediction by inputting measurements from the UE to the trained ML model to identify at least one of the plurality of beams to use for the wireless communications; or perform the network-side DL beam prediction by at least one of: inputting the UE-side DL beam prediction to the trained LSTM RNN to identify at least one of the plurality of beams to use for the wireless communications; or inputting the UE-side DL beam prediction and downlink (DL) beam measurements, performed by the UE, to the trained deep reinforcement learning model to identify at least one of the plurality of beams to use for the wireless communications.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network apparatus and a user equipment apparatus (UE), according to one illustrated aspect of the present disclosure;

FIG. 2 is a timing diagram of an example embodiment of a user equipment apparatus sweeping receive beams for Synchronization Signal Block (SSB) bursts, according to one illustrated aspect of the present disclosure;

FIG. 3 is a diagram of an example embodiment of an SSB allocation for multi-transmission receipt points (TRP), according to one illustrated aspect of the present disclosure;

FIG. 4 is a diagram of an example embodiment of UE beamforming with multi-panel configuration, according to one illustrated aspect of the present disclosure;

FIG. 5 is a diagram of an example embodiment of a machine learning (ML) model for beam prediction in a spatial domain, according to one illustrated aspect of the present disclosure;

FIG. 6 is a diagram of an example embodiment of a machine learning model for beam prediction in a time domain, according to one illustrated aspect of the present disclosure;

FIG. 7 is a diagram of an example embodiment of a beam prediction at a network side utilizing deep reinforcement learning, according to one illustrated aspect of the present disclosure;

FIG. 8 illustrates an example embodiment of a flow diagram of beam prediction at a UE side using the ML models of FIG. 5 and/or FIG. 6, according to one illustrated aspect of the present disclosure;

FIG. 9 illustrates an example embodiment of a flow diagram of beam prediction at a UE side in a spatial domain and a time domain, according to one illustrated aspect of the present disclosure;

FIG. 10 illustrates an example embodiment of a flow diagram of network-side down link (DL) beam prediction using the ML model of FIG. 7, according to one illustrated aspect of the present disclosure; and

FIG. 11 illustrates an example embodiment of components of a user equipment apparatus or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

In recent years, wireless networking technology has benefited with beamforming configurations. By transmitting an array of beams from a cell tower, a user with a UE device can select and connect with the beam or a cell that provides the strongest signal. In some cases the selection is performed by the network i.e. the strongest or the beam that provides adequate communication quality but may provide higher capacity (i.e., through increased scheduling opportunities) may be selected. Although the process can improve the quality of the connection, the method does add complexity to the communication process.

The beam management process is specified by 3GPP for full buffer traffic users, where there is continual traffic and for file transfer protocol traffic (FTP3) users. In some embodiments, some users are in an idle mode more often than other users and some users are in a fully connected mode. In operation, the beam management process includes transmitting Synchronization Signal Block (SSB) bursts to support each beam, which can increase by large numbers the measurements required from UEs for down-link (DL) beam selection at a network apparatus 110, e.g., a gNB. Therefore, the efficiency in making beam predictions could improve if the number of measurements and the frequency of measurement were reduced.

Aspects of the present disclosure relate to AI/ML beam management in a wireless network to improve efficiency of beam selection. Aspects of the present disclosure provide various advantages, including a reduction in the number of measurements as well as the frequency of measurements required for beam management selection.

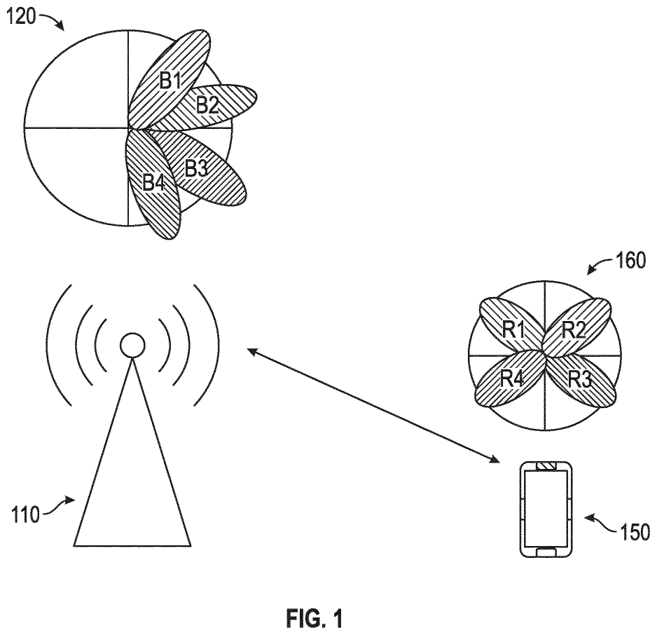

FIG. 1 is a diagram depicting an example of wireless networking between a network apparatus 110 and a user equipment apparatus (UE) 150. The network apparatus 110 is configured to form beams 120 in multiple directions, and the UE 150 is also configured to form beams 160 in multiple directions. As persons skilled in the art will understand, the capability to beamform in multiple directions may be implemented using arrangements of multiple radiating elements, which may also be referred as “arrays” of radiating elements. Beamforming (also known as spatial filtering) achieves directional signal transmission or reception by utilizing separate arrays and/or by combining elements in an array in such a way that signals at particular angles experience constructive interference while others experience destructive interference. The description below may refer to a “broad beam.” Persons skilled in the art will understand and recognize a broad beam for any given array. For example, persons skilled in the art will understand and recognize a broad beam based on half power beam width. In embodiments, a broad beam may be produced by a single radiating element of an array or by multiple radiating elements with specific weights (i.e., phase shifter settings).

Examples of wireless networking apparatuses that apply beamforming in multiple directions include, without limitation, apparatuses implementing 5G NR and apparatuses implementing Wi-Fi 6, among others. The present disclosure describes embodiments related to 5G NR (and generations beyond 5G) and embodiments which involve aspects defined by 3rd Generation Partnership Project (3GPP). With respect to such embodiments, the network apparatus 110 may be a gNodeB (also known as gNB). However, it is contemplated that embodiments relating to other wireless networking technologies are encompassed within the scope of the present disclosure.

In radio communications, a node may be implemented, at least partly, by a centralized unit, CU, (e.g., server or host) that is operationally coupled to one or more distributed units, DU, (e.g., a radio head). In embodiments, it is possible that node operations may be distributed among multiple centralized units (e.g., servers or hosts). In embodiments, a network node in 5G wireless networking may be implemented based on a so-called CU-DU split. In embodiments, a processing task may be performed in either the CU or the DU, and the shifting of responsibility between the CU and the DU may be configurable according to a particular implementation.

With continuing reference to FIG. 1, in the example of a 5G NR network, the network apparatus 110 provides a cell, which defines a coverage area of the network apparatus 110. As described above, the network apparatus 110 may be a gNB of the 5G NR network or may be any other apparatus configured to control radio communication and manage radio resources within a cell. As used herein, the term “resource” may refer to radio resources, such as a physical resource block (PRB), a radio frame, a subframe, a time slot, a sub-band, a frequency region, a sub-carrier, a beam, etc. In embodiments, the network apparatus 110 may be called a base station.

The UE 150 may include, but is not limited to, a smartphone, a tablet, portable computers, vehicle-mounted wireless terminal devices, an Internet of Things (IOT) device, and/or a watch or other wearable device, among others. The network apparatus 110 may provide the UE 150 with wireless access to other networks, such as the Internet. The wireless access may include downlink (DL) communication from the network apparatus 110 to the UE 150 and uplink (UL) communication from the UE 150 to the network apparatus 110. As used herein, the term “transmission” and/or “reception” may refer to, respectively, wirelessly transmitting and/or receiving via a wireless propagation channel on radio resources. There may be other UE in the cell, and each of them may be serviced by the same or by different network apparatuses, such as network apparatus 110.

3GPP defines 5G NR frequency ranges, such as Frequency Range 2 (FR2) covering 24.25 GHz to 52.6 GHz, which include high frequencies and include bands having very high bandwidths that can accommodate high data rate use cases. Such bands may be subject to challenging propagating conditions, such as high path loss, absorption from the environment, and penetration losses, among other conditions. To address such conditions, beam management procedures may be used, such as using highly directive beams at the network apparatus 110 and at the UE 150.

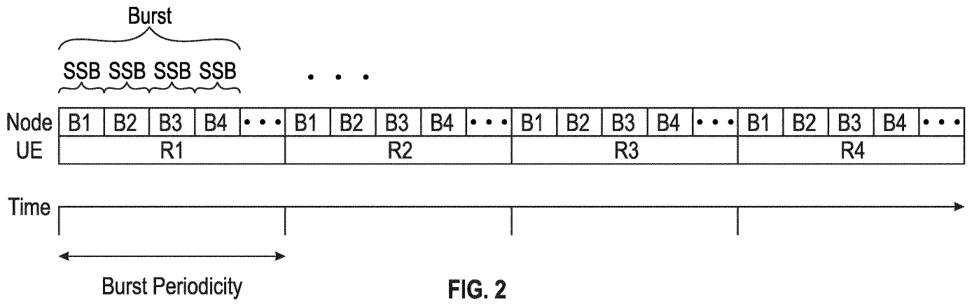

With continuing reference to FIG. 1, various examples of beams 120 are illustrated for the network apparatus 110 and various examples of beams 160 are illustrated for the UE 150. A consequence of using highly directive beams is that some of the network apparatus beams 120 may not be usable with some of the UE beams 160 due to large directional differences. Thus, the UE 150 “sweeps” its beams 160 and the network apparatus 110 “sweeps” its beams 120 to determine which beam-pairing has the highest signal power and, therefore, is best usable for communications. It is possible for beams that are not fully directionally-aligned to have the highest signal power due to various propagating conditions. The sweeps will be described in more detail in connection with FIG. 2. After identifying such a beam pairing, the UE 150 and the network apparatus 110 may use the identified beams to initiate access procedures for the UE 150 to access the network apparatus 110.

Referring additionally to FIG. 2, an example of beam sweeping for the example of a 5G NR network is shown. Using the example beams illustrated in FIG. 1, the network apparatus 110 form beams B1, B2, B3, and B4, successively. Each formation of the beams is referred to as a “burst.” The network apparatus 110 may generate the bursts at intervals for the UE 150 to observe. Each time between intervals is referred to as “burst period,” which may be longer than the duration of a burst. As persons skilled in the art will understand, beamforming for a transmission is implemented by controlling the phase and relative amplitude of the transmission signal at each radiating element in an array, in order to create a desired pattern of constructive and destructive interference in a desired wavefront. Beamforming for a reception, in contrast, is implemented by combining information from different elements of an array in such a way that radiation in a target spatial region is preferentially observed.

In the example of 5G NR, each beam in a burst transmits information about the beam in what is referred to as a Signal Synchronization Block (SSB). A network apparatus 110, which may be a gNodeB, transmits an SSB in each beam in a burst. In embodiments, the UE 150 may receive an SSB burst for each of its receive beams. In the example of four receive beams R1, R2, R3, and R4, shown in FIG. 1, receiving the bursts takes four intervals, as shown in FIG. 2. The duration between bursts is referred to as “burst periodicity.” In a 5G NR network, SSB bursts can each last 5 ms, and burst periodicity can have a default duration of 20 ms. Any of the aspects herein are not limited to a particular downlink reference signal. As an example, a downlink beam may be identified by CSI-RS (channel state information reference signal) identifier and/or by synchronization signal block (e.g., SS/PBCH block, synchronization signal physical broadcast channel) identifier and/or any reference signal/sequence transmitted using the beam/spatial filter.

In the example of 5G NR, each SSB includes System Information (SI) in the form of Master Information Blocks (MIB) and a number of System Information Blocks (SIB). The SI is divided into Minimum SI and Other SI. Minimum SI includes basic information usable for accessing the network node and information for acquiring any other SI. Minimum SI includes the MIB, which contains cell-barred status information and physical layer information of the cell for receiving further system information (e.g., CORESET#0 configuration). MIB is periodically broadcast on a broadcast channel (BCH). Minimum SI also includes a System Information Block 1 (SIB1), which defines the scheduling of other system information blocks and contains information for accessing the network node. SIB1 may also be referred to as Remaining Minimum SI (RMSI) and is periodically broadcast on a downlink shared channel (DL-SCH).

More specifically, in embodiments, a MIB on a public broadcast channel (PBCH) may provide a UE 150 with parameters (e.g., CORESET #0 configuration) for monitoring a public downlink control channel (PDCCH) for the schedule of a public downlink shared channel (PDSCH) that carries a SIB1. In embodiments, a PBCH may indicate that there is no associated SIB1, in which case the UE 150 may be pointed to another frequency in which to search for an SSB that is associated with a SIB1, and may be pointed to a frequency range where the UE 150 may assume no SSB associated with SIB1 is present. The indicated frequency range may be confined within a contiguous spectrum allocation of the same operator in which SSB is detected.

With continuing reference to FIG. 2, for each transmit-receive beam pair, the UE 150 measures a reference signal received power (RSRP). In embodiments, the beam pair with the maximum RSRP is selected. In embodiments, any beam pair with sufficient RSRP may be selected. Once the beam pair is identified, the UE 150 decodes the SSB of the selected network node transmit beam and decodes its contents, such as a MIB and/or a SIB1. As mentioned above, a MIB contains information of a cell for receiving further system information, and SIB1 defines the scheduling of other system information blocks and contains information for accessing the network node. Such information may be used by the UE 150 to establish a connection with the network apparatus 110.

The examples of FIGS. 1 and 2 are merely illustrative. In embodiments, the number and direction of network node beams and the number and direction of UE beams may vary and may be different from those illustrated in FIGS. 1 and 2.

After a beam pair is identified (e.g., during RACH), the UE 150 forms an initial connection with the network apparatus 110. As conditions change, a beam pairing may become suboptimal, and the UE 150 may scan SSBs again to measure RSRP and provision to the measurement results to the network. Such repeated scanning consumes power at a UE 150. In accordance with aspects of the present disclosure, machine learning may be used to reduce the frequency of SSB scans by a UE 150 by predicting a downlink beam to use for (future) communications with a network apparatus 110. In any of the aspects herein, the scanning or measurements or ML based prediction may apply to any reference signal (such as SSB, CSI-RS, any sequence or reference signal).

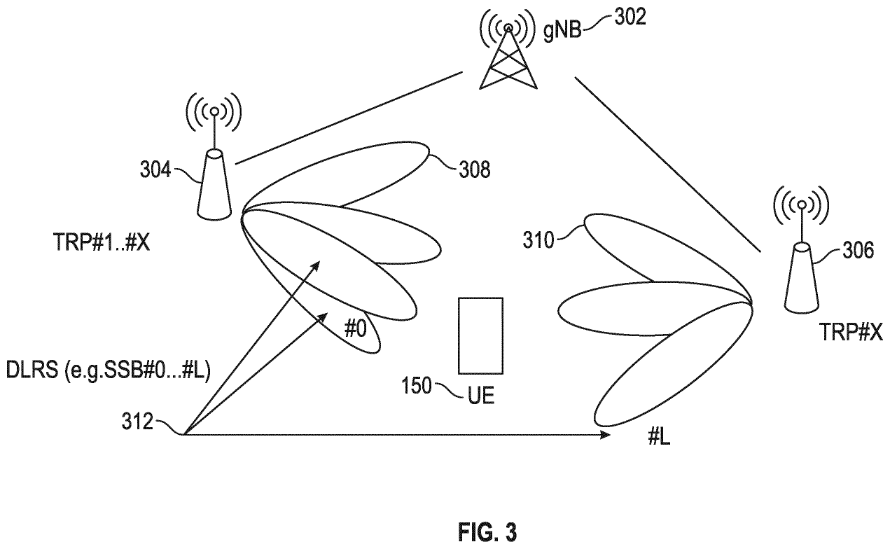

FIG. 3 is a diagram of an example embodiment of an SSB allocation for multi-transmission reception points (TRP), according to one aspect of the present disclosure. As illustrated, the network of FIG. 3 includes base station gNB 302, cell 304, cell 306, UE 150, an array of beams 308 transmitted from cell 304, and an array of beams 310 transmitted from cell 306. As illustrated, one gNB may have one or more cells. The 3GPP NR 5G may be considered as a native beam system, that is, a system that operates on a specific platform.

As illustrated in FIG. 3, cell 304 area may be covered using an array of one or more beams 308 provided by one or more TRPs. (#1 . . . #X), Transmission/Reception Points of cell 304. The array of beams 310 is associated with TRP #X. Each beam 308 and beam 310 may carry an identifier enabling UE 150 to identify a beam and perform measurements (e.g., received power, RSRP reference signal received power) and associate the measurements with a specific identifier. As an example, cell 304 is covered by a downlink reference signal (DLRS) 312. As illustrated in FIG. 3, the DLRS 312 that includes L SSBs (SSB #0 . . . #L). Each SSB can be identified based on the identifier carried by the SSB block (SSB time location index). SSB block also carries the identifier for which the cell it is associated. In some embodiments, SSBs are transmitted in an SSB burst set, where the SSB burst set has a periodicity of X milliseconds, and where the SSB of a cell are transmitted in predetermined time locations. Aspects of these points were described relative to FIG. 2.

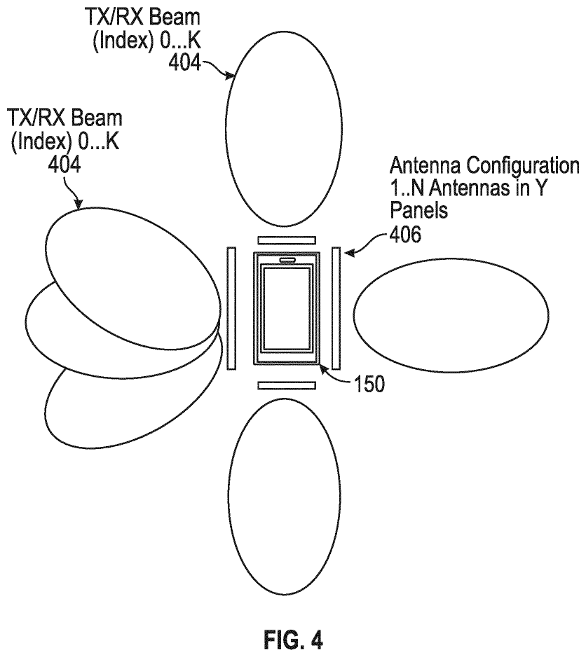

FIG. 4 is a diagram of an example embodiment of UE beamforming with multi-panel configuration, according to one illustrated aspect of the present disclosure. 5G NR can also support UE beamforming. FIG. 4 illustrates UE 150, antenna configuration 1 406, including N antennas in Y panels, and Tx/Rx beam (index) 0 . . . K.

In lower frequencies, UE 150 may not use beamforming and may operate with an omnidirectional beam (e.g., equal gain on all directions for transmission and/or reception). However, in higher frequencies (e.g., above 6 Ghz) UE 150 may have one or more antenna panels 406 that form one or more beams as illustrated in FIG. 4. In some examples, it may be possible to label/index the panels used by the UE 150 and in some examples, each individual beam that UE 150 is capable of forming may have separate index.

As previously described herein, in some embodiments, AI/ML management mechanisms can be applied to beam prediction methods in order to reduce the number of measurements as well as the frequency of measurements in a network, such as the network illustrated in FIG. 3.

First, for the UE 150 side, the present disclosure proposes that the network apparatus 110 can configure the UE 150 to perform machine learning-based beam prediction in both a time domain and a spatial domain. Hence, the ML model is one of a time-domain neural network or a spatial-domain neural network. With this proposed method, the UE side can predict DL beam ID(s), DL beam RSRP, and/or DL beam signal to interference noise ratio (SINR) (and in case of beam reciprocity, the gNB DL beam prediction can also be used for UL). The measurements reported and measurements performed by UE 150 can be reduced significantly. In some aspects, the downlink beam prediction may be used for uplink wireless communication, e.g., via the reciprocity principle, wherein a downlink beam pattern is used for the reception of an uplink transmission.

Second, at the network apparatus 110 side, an effective mechanism to allocate downlink (DL) or uplink (UL) beams needs to be identified in order to maximize the KPI, i.e., signal strength, data rate, throughput mapped from RSRP/SINR values, and Channel Quality Indicator (CQI) values. A possible mechanism includes a method for management in a beam-based communication system where multi-agent ML-based prediction is used. Another possible mechanism is using a method for independent training networks in network apparatus 110 side and UE 150 side in both the spatial domain and the time domain.

Additionally, at the network apparatus 110 side, this present disclosure proposes an algorithm for deep reinforcement learning implementation where the KPI (reward) has been achieved. The proposal includes various conditions for the ML model to provide a penalty, i.e., when beam failure happens, when N-most recent (or N-predictions within a time window) is unsuccessful transmitted and etc. Moreover, the present disclosure provides a condition where the network apparatus 110 may not need to compute the reward, which leads to a complexity reduction of a deep reinforcement learning implementation.

With the aforementioned implementations at the network apparatus 110 where (i) the reliability objectives can be achieved while beam failure can be avoided, (ii) the success CQI values mapped from RSRP values of predicted DL beam ID while unsuccessful of N-predictions can be avoided, and (iii) the success CQI values mapped from SINR values of predicted DL beam ID while unsuccessful of N-predictions can be avoided.

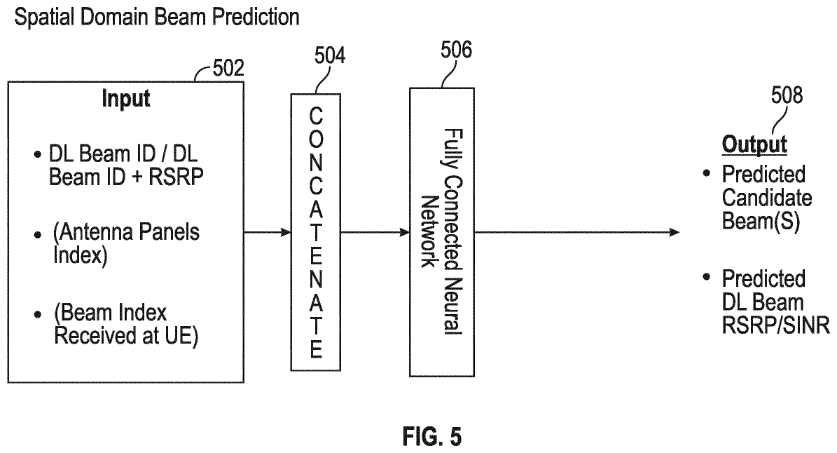

FIG. 5 is a diagram of an example embodiment of beam prediction using ML model 506 in a spatial domain, according to one illustrated embodiment of the present disclosure. The ML model 506 generally includes a fully connected feed-forward neural network (FNN) and/or convolutional neural network (CNN). For the CNN, a 1-dimenstion (1D) convolutional layer or 2-dimension (2D) convolutional layer may be added in order to pull the necessary features of the input before passing through the FNN layer. A fully connected layer refers to a neural network in which each neuron applies a linear transformation to the input vector through a weights matrix. As a result, all possible connections layer-to-layer are present, meaning every input of the input vector influences every output of the output vector. The spatial domain prediction, using the ML model 506, may be trained for a specific coverage area and its dynamics.

The ML network 506 may receive as input data 502, for example, a DL beam ID, RSRP, an antenna panel index, and/or a beam index received at the UE 150. In aspects, the inputs 502 may be concatenated 504 before being supplied to the ML model 506. The ML model 506 may output 508 a prediction including, for example, one or more predicted candidate beams, a DL beam RSRP, or a DL beam SINR. Instead of RSRP, the UE may utilize the SINR measurement as the input for the predictor and obtain an estimated SINR as output. Inputs 502 and outputs 508 define an inference process.

For example, beam prediction at the UE side using ML model 506 in the spatial domain may be performed as follows: the UE 150 concatenates the inputs 502 and feeds into ML model 506 to obtain the output 508, which includes predicted DL beam ID(s) and predicted DL beam RSRP/SINR, for time instance (t). One can obtain the antenna panels index, which is observed from the input. As previously noted, input 502 and output 508 define the inference process.

Alternatively, if the ML model 506 is trained to predict RSRP at time t for a set of beams, the beam at time t is predicted based on which one is predicted to have the highest RSRP at time t. The inference process is performed at each UE 150 that can be used for the beam selection or beam tracking at time t. The training of ML model 506 is performed based on measurement data.

In aspects, the network apparatus 110 may configure the UE 150 to perform downlink beam prediction (e.g., beam index and/or RSRP/SINR (Reference Signal Received Power/Signal to Interference plus Noise Ratio) and/or the corresponding UE panel/UE beam ID for the predicted DL beam ID).

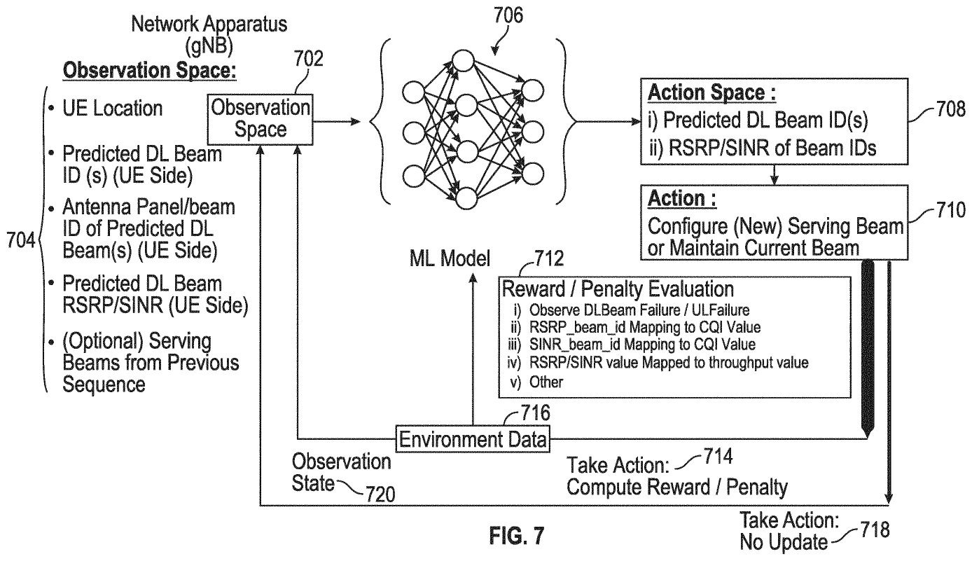

In aspects, the network apparatus 110 may configure the UE 150 to report the prediction results of ML model 506 and utilize the prediction results as an input for a network ML model (FIG. 7).

To use the ML model 506 for a different coverage area, the ML model 506 may need to be trained again.

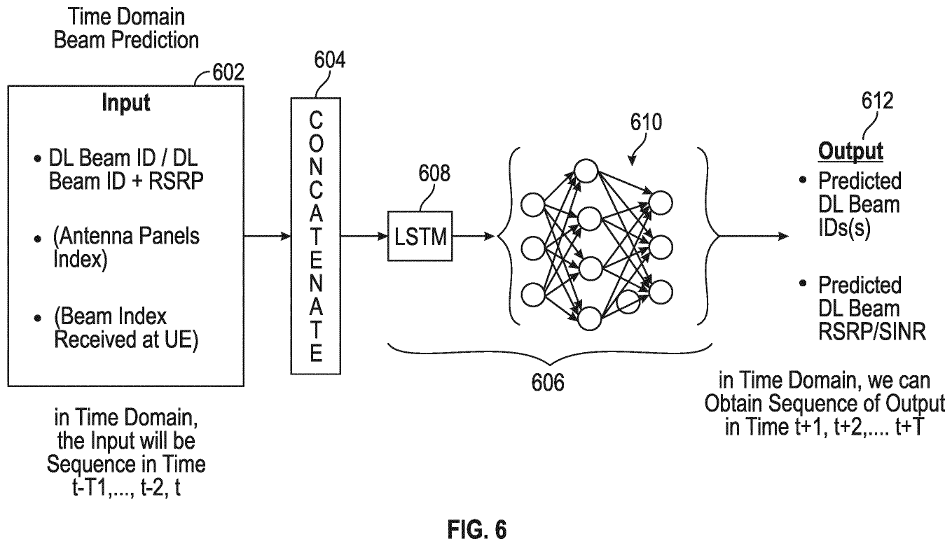

Referring to FIG. 6, a diagram of an example embodiment of time domain beam prediction 600 using ML model 606 is shown.

ML model 606 may be implemented with a recurrent neural network (RNN). RNNs differ from feed-forward neural networks in that they have connections to neurons of the same layer or of previous layers. While feed-forward neural networks do not have any sense of time, i.e., each input is processed in the same way, independent of previous inputs, RNNs can keep an internal state through these interconnections, which are updated each timestep.

The ML model 606 generally includes a long-short-term memory (LSTM 608) recurrent neural network (RNN) to generate an output 612. A recurrent neural network is a class of artificial neural networks where connections between nodes can create a cycle, allowing output from some nodes to affect subsequent input to the same nodes. This allows it to exhibit temporal dynamic behavior.

The ML model 606 may receive as input data 602, for example, a DL beam ID, RSRP, an antenna panel index, and/or a beam index received at the UE 150. In aspects, the inputs 602 may be concatenated 604 before being supplied to the ML model 606. The ML model 606 may output 608 a prediction including, for example, one or more predicted candidate beams, a DL beam RSRP, or a DL beam SINR, in the time domain. Instead of RSRP, the UE may utilize the SINR measurement as the input for the predictor and obtain an estimated SINR as output. Inputs 602 and outputs 608 define an inference process. Since the ML model 606 prediction is in the time domain, input 602 will be sequenced in time (i.e., t+1, t+2, . . . t+T).

The ML model 606 is configured to output 612, for example, predicted candidate beam(s), DL beam ID(s), DL beam RSRP, or an SINR, in the time sequence.

Output 612 may include, for example, a predicted candidate beam(s) and/or predicted DL beam RSRP/SINR. Since the ML model 606 prediction is in the time domain, output 612 can be sequenced in time, t+1, t+2, . . . t+T. For example, instead of using RSRP, the UE 150 may utilize the SINR measurement as the input for the predictor and predict an estimated SINR in time sequence as output. In aspects, if the ML is trained to predict RSRP sequence (in time sequence) for the set of beams, the beam predicted is based on which beam is predicted to have the highest RSRP (in time sequence, i.e., t+1, t+2, .... t+T). In aspects, if the ML is trained to predict DL beam sequence (in time sequence), the output can be beam(s) (in time sequence, i.e., t+1, t+2, .... t+T) that have RSRP value above a threshold (e.g., detection threshold or a configured threshold value).

The inference process is performed at each UE that can be used for beam selection or beam tracking at both UE and network apparatus sides. The inference process is based on input 602 and output 612. The training of the LSTM-RNN is performed based on measurement data.

FIG. 7 is a diagram of an example embodiment of a beam prediction at a network side (e.g., network apparatus 110) utilizing deep reinforcement learning (DRL) based LSTM-RNN. The ML model 706 utilizes reinforcement learning to predict DL beam ID(s), RSRP, and/or SINR of beam ID(s). Reinforcement learning is a machine learning training method based on rewarding desired behaviors and/or punishing undesired ones. In general, a reinforcement learning agent is able to perceive and interpret its environment, take actions and learn through trial and error.

The ML model 706 observes the observation space 702 to provide inputs to the ML model 706. Inputs 704 in the observation space 702 may generally include at least one of a UE location, a predicted DL beam ID(s) from the UE side, an antenna panel/beam ID, predicted DL beams(s) from the UE side, a predicted DL beam RSRP/SINR from the UE side, or serving beams from a previous sequence. The observation space 702 may include serving beams from a previous sequence.

Based on the inputs, the ML model 706 predicts an action space 708, such as predicting DL beam ID(s) and/or RSRP/SINR of beam IDs. Based on the observation space 702 and the action space 708, the ML model 706 generates an action 710. Actions 710 may include, for example, configuring a new serving beam or maintaining the current beam.

The action 710 is evaluated 712 by the ML model 706 for rewards and/or penalties. The reward/penalty evaluation 712 includes, for example, observing DL beam failure/UL failure, RSRP_beam_id mapping to CQI value, SINR_beam_id mapping to CQI value, and/or other status. Based on the results of the reward/penalty evaluation 712, the ML model 706 may either not update 718, provide a reward, and/or provide a penalty 714. The results of the action 710 are fed into the observation space 702 for further use by the ML model 706 in performing predictions. The reward may be designed in a way to achieve the KPIs, i.e., RSRP of predicted DL beam ID(s) (RSRP_beam_id(s)) that are selected as serving beams >mapped to CQI. SINR values of predicted DL beam ID(s) (SINR_beam_id(s)) that are selected as serving beams--->mapped to CQI. The reward may be determined from the action space of the downlink predicted beam ID(s) and RSRP/SINR of downlink beam ID(s).

In some embodiments, the ML model 706 may utilize one or more prediction outputs values of the ML model 506, 606 (FIGS. 5 and 6) of UE 150 as one or more input values for a network side ML model 706 and generate a prediction output by the network side ML model 706 based on one or more input values.

The network-side training method includes evaluation for the network-side prediction outcome based on at least one metric, using the metric to determine whether to update/reward the current model based on the UE input.

A beam prediction can be provided by a network apparatus 110, such as a gNB/transmitter base station. A method can include performing, by the network apparatus 110, the network-side DL beam prediction by inputting the UE-side DL beam prediction to the trained ML model 706 (e.g., an LSTN RNN) to identify at least one of the plurality of beams. The network apparatus 110 may use deep reinforcement learning (DRL) to predict top-K beams/downlink beams ID(s) and RSRP/SINR of the beam ID(s). The predicted top-K beams/downlink beams Id(s) and RSRP/SINR of the beam ID(s) dynamically interact with the environment. Additionally, a proximal policy optimization (PPO) based actor-critic is utilized for DRL implementation. For DRL, the input and output of prediction (inference process) can be based on inputs 704 and action space 708.

The training and inference for the ML model 706 can happen while interacting with the environment. In this embodiment, pretrained model obtained from a ML model at the UE 150 side can be used as one of the inputs for the ML model 706. The DRL can be trained during the deployment for the specific network coverage area that it is deployed in. After obtaining the predicted downlink beam ID(s), and predicted downlink beams RSRP/SINR from the UE side. In aspects, the network apparatus 110 may use a pre-trained ML model 706. The network apparatus 110 uses them as information for input to neural networks.

In aspects, the ML model 706 may be trained to predict the DL beam ID(s) and the RSRP/SINR of beam ID(s) in spatial domain prediction. In another embodiment, the deep reinforcement learning-based neural network can be trained to predict the DL beam ID(s) and the RSRP/SINR of beam ID(s) in both time domain and spatial domain depending on the inputs. The input format can be in time sequence (i.e., t−T, . . . t−2,t−1,t). In this time sequence input, the ML model 706 which is implemented in DRL can be modeled as a time series neural network. Hence, the action space 708 and the reward/penalty evaluation 712 can be considered in a sequence of the time domain.

The inference process for the network apparatus 110 may be performed with the knowledge of the inference process at UE 150, which may be used for beam selection or beam tracking and beam switching process.

Benefits may include reduced UE measurements/reporting, which in turn reduces UE power consumption, and/or reduced resource utilization in a cell for uplink reporting, which increases the efficiency of the cell/system.

In aspects, for each prediction, the ML model 706 can obtain at least one DL beam ID prediction provided by the ML model 706, to determine whether a new serving beam may be configured for at least one of a physical uplink shared channel (PUSCH), a physical uplink control channel PUCCH, a physical data shared channel PDSCH, or a physical data control channel PDCCH), e.g., if the prediction provides at least one beam ID in the top K-beams that is already a serving beam, the ML model 706 may not update the serving beam and/or beams to UE 150. The determination can be performed for each channel separately or the same beam may be used for each of the DL/UL channels). Note that even if the same beam is used, it can be considered as selected.

In other examples, the network may determine to always select the beam based on the prediction and select that beam as a new serving beam (if a new ID is different than the current) for at least one DL or UL channel.

In aspects, the ML model 706 may estimate the reliability of a UE ML model 506, 606, prediction and determine to update the ML model based on the reward/penalty calculation. To determine whether to update or not may be based on at least one quality-based metric. The quality-based criteria may be one of the following criteria: i) beam failure or ii) predicted CQI value based on the predicted RSRP iii) use the predicted SINR value to map to CQI value iv) or other factors.

For criterion i) described above, the N-most recent (or N-predictions within a time window) UE predictions are provided by the ML model 706. The UE prediction can determine whether a beam failure (e.g., a link is not able to be used for communication with UE 150) has occurred or not. This evaluation may be used, e.g., for PDCCH beams.

Reward/penalty evaluation 712 relative to criterion i) will now be described.

Penalty condition: If a beam failure occurs, the network determines the N-most recent/N predictions/N-valid predictions and calculates->if the one PDCCH beam is in failure, a given failure L prediction out of N transmissions/reception is performed. If more than one PDCCH beams up to some K1 PDCCH beams are in failure, L1 out of N unsuccessful transmissions/reception is performed. Then, if more than K1 PDCCH beams are in failure, the L2 out of N unsuccessful transmissions/reception are performed. The penalty is calculated according to the L, L1, or L2 depending on the number of PDCCH beams that are in failure.

Reward condition: If a beam failure does not occur, the network determines the M-most recent/M-predictions/M-valid predictions and calculates the reward, and updates the network model.

No update with the environment: If all the PDCCH beams are in failure, then the gNB may not update the reward function. In this case, the ML model 706 may determine the new action space according to the observation space without interacting with the environment, as shown in FIG. 7. Note that: M and N are variables (N, M=1,2,3,4 ...) , L, L1, L2 are the number failure detection depends on the number of PDCCH in failures (L, L1, L2=1,2,3,4) and L, L1, L2 are the subset of N.

For criterion ii) described above, the predicted RSRP is used to derive an estimation for a CQI value. In order to estimate the CQI, the network may assume an interference level for the calculation or ignore the interference component and use SNR (signal-to-noise ratio) to estimate the value for a CQI. This may be used, for example, for PDSCH/PUSCH beams.

CQI refers to a channel quality indicator value that refers to an indicated/used combination of modulation and coding for a transmission (by UE or by NW). the CQI is only one example of a quality metric. As an example, in some examples, the network apparatus 110 can measure RSRP of a UE uplink transmission and compare the predicted RSRP with the measured one. Alternatively, RSRP/SINR value could be further mapped to an assumed data rate (via CQI or directly) that is assumed to be supported by the predicted CQI, further determining whether the data rate was supported (if supported->reward, if not penalty). Reward/penalty evaluation 712 relative to criterion ii) will now be described.

Penalty condition: RSRP value of a predicted DL beam ID (RSRP_beam_id) that is selected as a serving beam is mapped to a CQI value->if at least one, N or N/M unsuccessful transmissions/reception are performed using the predicted CQI, the penalty is calculated, and model is updated. The calculation may be performed within a time period.

Reward condition: RSRP value of a predicted DL beam ID (RSRP_beam_id) that is selected as a serving beam is mapped to a CQI value->if at least one, N or N/M successful transmissions/reception are performed using the predicted CQI, the reward is calculated and the ML model 706 is updated. The calculation may be performed within a time period.

For criterion iii) described above, the UE may be configured to perform SINR measurements and provide the ML model 706 with the predicted SINR (in addition to DL beam index and/or UE beam panel/beam index). Reward/penalty evaluation 712 relative to criterion iii) will now be described.

Penalty condition: SINR value of a predicted DL beam ID (SINR_beam_id) that is selected as a serving beam is mapped to a CQI value->if at least one, N or N/M unsuccessful transmissions/reception are performed using the predicted CQI, the penalty is calculated, and model is updated. The calculation may be performed within a time period.

Reward condition: SINR value of a predicted DL beam ID (SINR_beam_id) that is selected as a serving beam is mapped to a CQI value->if at least one, N or N/M successful transmissions/reception are performed using the predicted CQI, the reward is calculated, and model is updated. The calculation may be performed within a time period.

In aspects, other rewards and penalties may include observing an increase in UE throughput (reward), a reduction of UE throughput (penalty), an increase in cell throughput (reward), a reduction of cell throughput (penalty), a reduced number of retransmissions (reward), and/or increased retransmission (penalty). In a further example, if there are not enough transmissions/receptions possible by using the predicted beam (e.g., there is no scheduling or no date to be transmitted/received), then the ML model 706 update is not performed. Additionally, in one embodiment, the network apparatus 110 can configure the UE 150 to perform reporting of measurements on at least one downlink beam ID (DL RS, downlink reference signal) and feed them to the ML model 706. As an example, the ML model 706 may be trained to comply with the UE-reported prediction results or comply with UE-reported (actual) beam measurements.

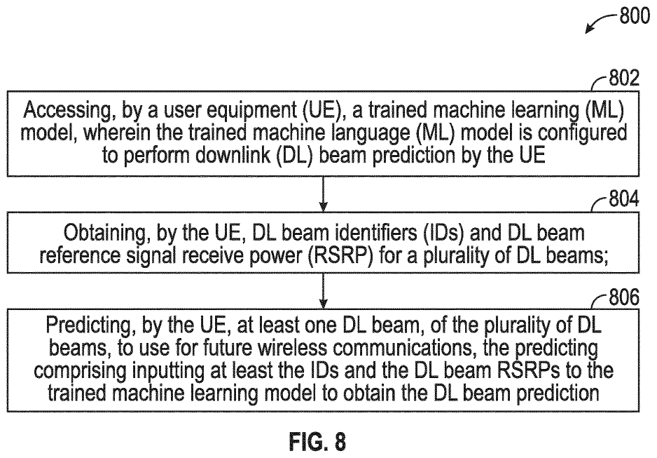

Referring now to FIG. 8, there is shown a flow diagram of an example of beam prediction at a UE side using a trained machine learning model to obtain the DL beam prediction.

At block 802, the UE operation involves accessing, by the UE 150, a trained ML model configured to perform downlink (DL) beam prediction by the UE. The operation may utilize the ML model 506 of FIG. 5 for predictions in the spatial domain and/or the ML model 606 of FIG. 6 for predictions in the time domain. For predictions in the spatial domain, the ML model 506 may be a fully connected feed-forward neural network and/or a CNN. In aspects, for predictions in the time domain, the ML model 606 may be a recurrent neural network for predicting the at least one DL beam to use for wireless communications, the recurrent neural network including long short-term memory (LSTM).

At block 804, the UE operation involves determining, by the UE 150, at least one of DL beam identifiers (IDs) for a plurality of DL beams or DL beam reference signal received power (RSRP) for a plurality of DL beams.

At block 806, the UE operation involves predicting, by the UE 150, at least one DL beam of the plurality of DL beams to use for (future) wireless communications. The predicting includes inputting at least one of the beam IDs or the DL beam RSRP to the trained ML model to obtain the DL beam prediction.

In aspects, the ML model performs network-side DL beam prediction in at least one of a time domain or a spatial domain.

In aspects, the ML model may perform DL beam prediction in a spatial domain by receiving, by the UE 150, a measurement of, for example, a DL beam ID and/or a DL beam SINR. The UE operation may involve providing as an input to the trained ML model the at least one of the DL beam ID or the DL beam SINR. The UE operation may involve predicting, by the trained ML model, an SINR value for the DL beam ID for a time instance (t).

In aspects, the ML model may perform transmitting, by the UE 150, one or more prediction outputs values of the UE ML model as an input to a network side ML model. The transmitted one or more prediction output values may be configured to cause the network-side ML model to generate a prediction output based on the input received from the UE 150.

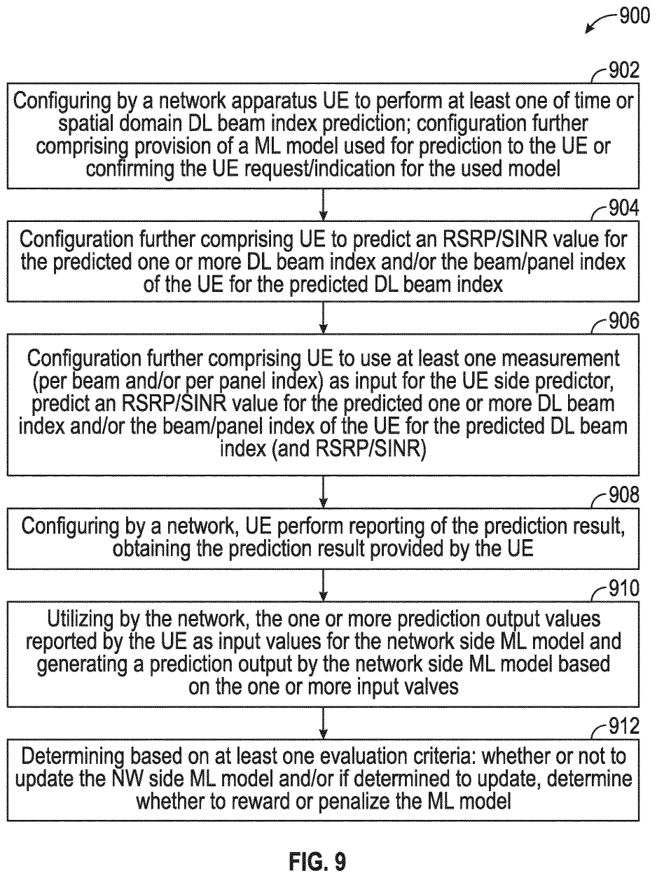

FIG. 9 illustrates an example embodiment of a flow diagram of configuring a ML model at a UE side by a network apparatus for beam prediction at a UE side.

At block 902, the UE operation involves receiving, from network apparatus 110, configuration information for an ML model used for the prediction of a DL beam index by the UE 150. The DL beam index prediction may be made in the time domain or the spatial domain. In aspects, the UE operation may involve confirming a request/indication for the ML model used.

At block 904, the UE operation involves predicting an RSRP/SINR value for the predicted one or more DL beam indexes and/or beam/panel index of the UE 150 for the predicted beam index in response to the configuration information from the network apparatus 110.

At block 906, the UE operation involves using at least one measurement (per beam and/or per panel index) as input for the UE side predictor in response to the configuration information from the network apparatus 110. In aspects, the UE operation may involve predicting an RSRP/SINR value for the predicted one or more DL beam index and/or the beam/panel index of the UE for the predicted DL beam index (and/or RSRP/SINR).

At block 908, the UE operation involves performing reporting of the prediction result in response to the configuration information from the network apparatus 110.

In aspects, the UE operation may involve transmitting the prediction result provided by the UE to the network apparatus 110.

At block 910, the UE operation involves causing the network apparatus 110 to utilize the one or more prediction output values reported by the UE as input values for the network side ML model and generate a prediction output by the network side ML model based on the one or more input valves.

At block 912, the UE operation involves determining, based on at least one evaluation criteria, whether or not to update the network apparatus 110 side ML model. In aspects, when it is determined to update the network apparatus 110 side ML model, the UE operation involves determining whether to reward or penalize the ML model.

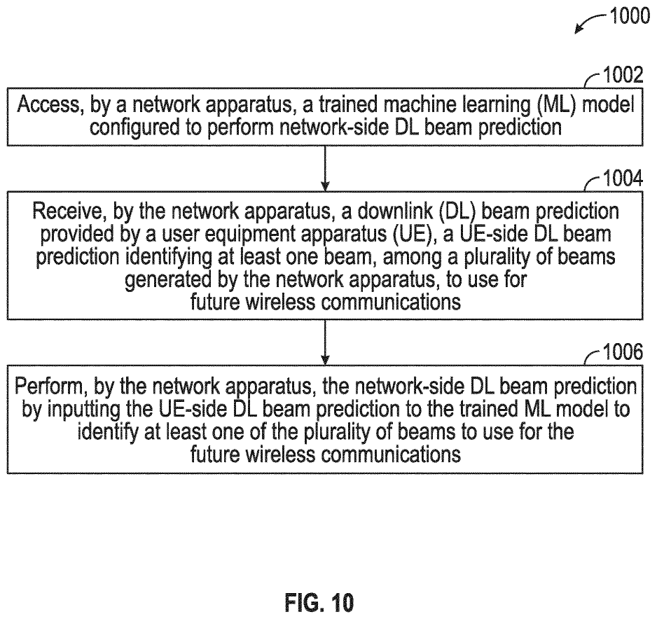

FIG. 10 illustrates an example embodiment of a flow diagram for a network-side DL beam prediction using the ML model 706 of FIG. 7.

At block 1002, the network apparatus operation involves accessing the ML model 706 configured to perform network-side DL beam prediction. The ML model 706 includes a trained long short-term memory (LSTM) recurrent neural network (RNN) or a trained deep learning LSTM RNN. In aspects, inputs for the ML model 706 include at least one of a DL beam index, a DL beam ID, reference signal received power (RSRP), an antenna panel index, and/or a beam index received at the UE.

At block 1004, the network apparatus operation involves receiving a downlink (DL) beam prediction provided by a user equipment apparatus (UE), a UE-side DL beam prediction identifying at least one beam, among a plurality of beams generated by the network apparatus, to use for (future) wireless communications.

At block 1006, the network apparatus operation involves performing the network-side DL beam prediction by inputting the UE-side DL beam prediction to the trained LSTM RNN to identify at least one of the plurality of beams to use for the (future) wireless communications.

In aspects, the ML model 706 performs network-side DL beam prediction in at least one of a time domain or a spatial domain.

In aspects, the ML model 706 is configured to predict at least one of the DL beam ID(s), RSRP of beam ID(s), and/or SINR of beam ID(s) based on the inputs for the ML model.

In aspects, the network apparatus operation involves for each prediction, obtaining at least one DL beam ID prediction provided by the ML model 706 to determine whether a new serving beam is configured for at least one of PUSCH, PUCCH, PDSCH, or PDCCH.

In aspects, the network apparatus operation involves determining whether to update the ML model or not, is based on using at least one quality-based metric, wherein a quality-based criteria includes one or more of the following: i) a beam failure or ii) a predicted CQI value based on a predicted RSRP iii) a predicted SINR value to map to CQI value.

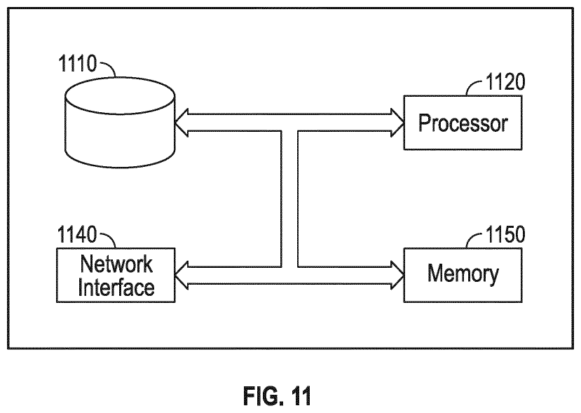

FIG. 11 illustrates an example embodiment of a block diagram of example components of the UE 150 or a network apparatus 110. The apparatus includes an electronic storage 1110, a processor 1120, a memory 1150, and a network interface 1140. The various components may be communicatively coupled with each other. The processor 1120 may be and may include any type of processor, such as a single-core central processing unit (CPU), a multi-core CPU, a microprocessor, a digital signal processor (DSP), a System-on-Chip (SoC), or any other type of processor. The memory 1150 may be a volatile type of memory, e.g., RAM, or a non-volatile type of memory, e.g., NAND flash memory. The memory 1150 includes computer-readable instructions that are executable by the processor 1120 to cause the apparatus to perform various operations, including the beam-pairing and random access procedures mentioned above.

The electronic storage 1110 may be and include any type of electronic storage used for storing data, such as hard disk drive, solid state drive, and/or optical disc, among other types of electronic storage. The electronic storage 1110 stores software instructions for causing the apparatus to perform its operations and stores data associated with such operations, such as storing data relating to 5G NR standards, among other data. The network interface 1140 may implement wireless networking technologies such as 5G NR, Wi-Fi 6, and/or other wireless networking technologies, and may include one or more arrays of radiating elements, such as those described in connection with FIGS. 1-7.

The components shown in FIG. 11 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1. A user equipment apparatus comprising:
accessing, by a user equipment apparatus (UE), a trained machine learning (ML) model configured to perform downlink (DL) beam prediction;
obtaining, by the UE, at least one of DL beam identifiers (IDs) for a plurality of DL beams or DL beam reference signal received power (RSRP) for a plurality of DL beams; and
predicting, by the UE, at least one DL beam, of the plurality of DL beams, to use for wireless communications, the predicting includes inputting at least one of the beam IDs or the DL beam RSRP to the trained ML model to obtain the DL beam prediction.

2. The method of claim 1, wherein the ML model performs DL beam prediction in a spatial domain, and
wherein the method further comprises:
receiving, by the UE, a measurement of at least one of a DL beam ID, DL beam RSRP, or a DL beam signal to interference noise ratio (SINR);
providing as an input to the trained ML model the at least one of the DL beam ID, DL beam RSRP, or the DL beam SINR; and
predicting, by the trained ML model, an SINR value for the DL beam ID for a time instance (t).

Example 3. The apparatus of Example 1, wherein the ML model performs DL beam prediction in at least one of a time domain or a spatial domain.

Example 4. The apparatus of Example 3, wherein for predictions in a spatial domain the ML model is a fully connected feed-forward neural network for predicting the at least one DL beam to use for the wireless communications.

Example 5. The apparatus of Example 3, wherein for predictions in the time domain the ML model is a recurrent neural network for predicting the at least one DL beam to use for wireless communications, the recurrent neural network includes long short-term memory (LSTM).

Example 6. The apparatus of Example 3, wherein the inputs for the ML model are sequenced in time, and outputs for the ML model are sequenced in time.

Example 7. The apparatus of any one of the preceding Examples, wherein for the DL beam prediction for one or more DL beam ID(s) is further based on at least one of an antenna panel index or a beam index received at the UE.

Example 8. The apparatus of any one of the preceding Examples the method includes transmitting, by the UE, one or more prediction outputs values of the UE ML model to the network. The apparatus of any one of the preceding Examples, the method includes transmitting, by the UE, one or more prediction outputs values of the UE ML model as an input to a network side ML model, wherein the transmitted one or more prediction output values are configured to cause the network side ML model to generate a prediction output based on the input received from the UE.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

1. A method, comprising:
accessing, by a user equipment apparatus, UE, a trained machine learning, ML, model configured to perform downlink, DL, beam prediction;
obtaining, by the UE, at least one of DL beam identifiers, IDs, for a plurality of DL beams or DL beam reference signal received power, RSRP, for a plurality of DL beams; and
predicting, by the UE, at least one DL beam, of the plurality of DL beams, to use for wireless communications, the predicting includes inputting at least one of the beam IDs or the DL beam RSRP to the trained ML model to obtain the DL beam prediction.

2. The method of claim 1, wherein the ML model performs DL beam prediction in a spatial domain, and
wherein the method further comprises:
performing, by the UE a measurement of at least one of a DL beam ID, the DL beam RSRP, or a DL beam signal to interference noise ratio, SINR;
providing as an input to the trained ML model the at least one of the DL beam ID, the DL beam RSRP, or the DL beam SINR; and
predicting, by the trained ML model, an SINR value for the DL beam ID for a time instance, t.

3. The method of claim 1, wherein the ML model performs DL beam prediction in at least one of a time domain or a spatial domain.

4. The method of claim 3, wherein for predictions in a spatial domain the ML model is a fully connected feed-forward neural network or a convolutional neural network for predicting the at least one DL beam to use for the wireless communications.

5. The method of claim 3, wherein for predictions in the time domain the ML model is a recurrent neural network for predicting the at least one DL beam to use for wireless communications, the recurrent neural network including long short-term memory, LSTM.

6. The method of claim 3, wherein the inputs for the ML model are sequenced in time, and outputs for the ML model are sequenced in time.

7. The method of claim 1, wherein for the DL beam prediction for one or more DL beam ID(s) is further based on at least one of an antenna panel index or a receive, RX, beam index received at the UE.

8. The method of claim 1, further comprising:
transmitting, by the UE, one or more prediction outputs values of the UE ML model as an input to a network side ML model, wherein the transmitted one or more prediction output values are configured to cause the network side ML model to generate a prediction output based on the input received from the UE.

9. A user equipment apparatus, comprising:
at least one processor; and
at least one memory storing instructions which, when executed by the at least one processor, cause the user equipment apparatus at least to:
access a trained machine learning, ML, model configured to perform downlink, DL, beam prediction;
obtain, DL beam identifiers, IDs, and DL beam reference signal receive power, RSRP, for a plurality of DL beams; and
predict, at least one DL beam, of the plurality of DL beams, to use for wireless communications, the predicting including inputting at least one of the beam IDs or the DL beam RSRP to the trained ML model to obtain the DL beam prediction.

10. A method, comprising:
accessing, by a network apparatus, a trained machine learning, ML, model configured to perform network-side DL beam prediction;
receiving, by the network apparatus, a downlink, DL, beam prediction provided by a user equipment apparatus, UE, a UE-side DL beam prediction identifying at least one beam, among a plurality of beams generated by the network apparatus, to use for wireless communications; and
performing, by the network apparatus, the network-side DL beam prediction by inputting the UE-side DL beam prediction to the trained ML model to identify at least one of the plurality of beams to use for the wireless communications.

11. The method of claim 10, wherein the trained ML model includes at least one of a long short-term memory, LSTM, recurrent neural network, RNN, or a deep learning LSTM RNN.

12. The method of claim 10, wherein the ML model performs network-side DL beam prediction in at least one of a time domain or a spatial domain,
wherein the ML model trains and takes actions based on a current observation space/current state, and
wherein the ML model performs prediction of at least one of network-side DL beam ID(s), RSRP of beam ID(s), or SINR of beam ID(s) based on deep reinforcement learning.

13. The method of claim 10, wherein inputs for the ML model include at least one of a DL beam index, a DL beam ID, reference signal received power, RSRP, an antenna panel index, or a beam index received at the UE.

14. The method of claim 13, wherein the ML model predicts at least one of the DL beam ID(s), RSRP of beam ID(s), or SINR of beam ID(s) in both time domain and spatial domain based on the inputs for the ML model.

15. The method of claim 13, wherein the inputs for the ML model are sequenced in time, and outputs for the ML model are sequenced in time.

16. The method of claim 10, further comprising:
estimating, by the network apparatus, a reliability of the of the UE prediction; and
determining whether to update the ML model based on a reward/penalty calculation.

17. The method of claim 11, wherein the training of the LSTM RNN comprises evaluating for the network-side DL beam prediction based on at least one metric, and using the at least one metric to determine whether to update/reward a current model based on a UE input.

18. The method of claim 10, further comprising, for each prediction, obtaining at least one DL beam ID prediction provided by the ML model to determine whether a new serving beam is configured for at least one of PUSCH, PUCCH, PDSCH, or PDCCH.

19. The method of claim 16, wherein determining whether to update the ML model or not, is based on using at least one quality-based metric, wherein a quality-based criteria comprises one or more of the following: i) a beam failure or ii) a predicted CQI value based on a predicted RSRP iii) a predicted SINR value to map to CQI value.

20. (canceled)
